(19) United States
(12) Patent Application Publication
(10) Pub. No.: US 2023/0311843 A1
(43) Pub. Date: Oct. 5, 2023

(54) ELECTRIC SUSPENSION APPARATUS AND VEHICLE

(71) Applicant: HONDA MOTOR CO., LTD., Tokyo (JP)

(72) Inventors: Satoshi OHNO, Wako-shi (JP); Kazuya KONADA, Wako-shi (JP)

(21) Appl. No.: 18/186,573

(22) Filed: Mar. 20, 2023

(30) Foreign Application Priority Data
Mar. 30, 2022 (JP) 2022-056667

(51) Int. Cl. B60W 10/30

(52) U.S. Cl. CPC B60W 10/30; B60W 2050/0016

(57) ABSTRACT

An electric suspension apparatus that is provided in a vehicle includes an electric actuator and a control ECU. The electric actuator is configured to be supplied with a high voltage from a battery. The control ECU is configured to control the battery and the electric actuator. The control ECU includes a stop determination part and an output control part. The stop determination part is configured to determine whether the vehicle is in a stopped state. The output control part is configured to stop output of the high voltage to the electric actuator based on time that elapses after the vehicle stops.

### CROSS-REFERENCE STATEMENT

The present application is based on, and claims priority from, Japanese Patent Application Number 2022-056667, filed Mar. 30, 2022, the disclosure of which is hereby incorporated by reference herein in its entirety.

### BACKGROUND

### Technical Field

The disclosure relates to an electric suspension apparatus and a vehicle.

### Related Art

Conventional techniques relating to an electric suspension apparatus that is provided in a vehicle and is driven by a motor are known.

Japanese Unexamined Patent Application Publication Number 2012-131395 (hereinafter “Patent Literature 1”) describes an electric suspension apparatus that sets output voltage (drive voltage of a motor) of a transformer, such as a DC-DC converter, as high as possible within a range of a predetermined voltage (for example, 48 V) or less. The transformer is configured to perform voltage transformation on electric power that is to be supplied to motors of electric actuators. The electric suspension apparatus drives high-voltage parts such as the motors.

In the electric suspension apparatus of Patent Literature 1, high voltage needs to be made absent from high voltage parts for safety reasons at times of a vehicle crash. To detect a vehicle crash, a supplemental restraint system (SRS) sensor signal, such as an activation signal of an airbag, is used. However, there may occur a form of crash in which the airbag is not activated but the electric suspension apparatus is destroyed. In this case, the electric suspension apparatus cannot rely on a safety measure that interrupts the high voltage to the high voltage parts based on the activation signal of the airbag. Because of this, there is a technique of arranging the motors in a physically protected area in a center portion of a vehicle so that the motors are distant from the electric suspension apparatus in four corners of the vehicle. However, since the motors are not directly mounted at positions where the electric suspension apparatus is mounted, this technique has a problem of increased system size due to driving being performed via links.

The conventional technique is unable to make high voltage absent from a high-voltage part in cases where the level of impact in a vehicle crash is such that the airbag is not activated.

### SUMMARY

An electric suspension apparatus according to an embodiment is an electric suspension apparatus that is provided in a vehicle. The electric suspension apparatus includes a high-voltage part configured to be supplied with a high voltage from a power supply and a controller configured to control the power supply and the high-voltage part. The controller includes a stop determination part configured to determine whether the vehicle is in a stopped state and an output control part configured to limit output of the high voltage to the high-voltage part based on time that elapses after the vehicle stops.

### BRIEF DESCRIPTION OF DRAWINGS

FIG. 1 is a configuration diagram of a vehicle equipped with an electric suspension apparatus according to at least one embodiment of the disclosure.

FIG. 2 is a configuration diagram of an electric suspension apparatus according to at least one embodiment of the disclosure.

FIG. 3 is a diagram showing an example of a configuration of an inverter of an electric suspension apparatus according to at least one embodiment of the disclosure.

FIG. 4 is a flow chart showing a high-voltage interruption control process of a control ECU of an electric suspension apparatus according to at least one embodiment of the disclosure.

FIG. 5 is a timing chart showing an example of high-voltage interruption control of the control ECU of an electric suspension apparatus according to at least one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An embodiment of the disclosure is described in detail with reference to the drawings. Note that, in the drawings, common portions are denoted by the same reference signs, and overlapping description is omitted.

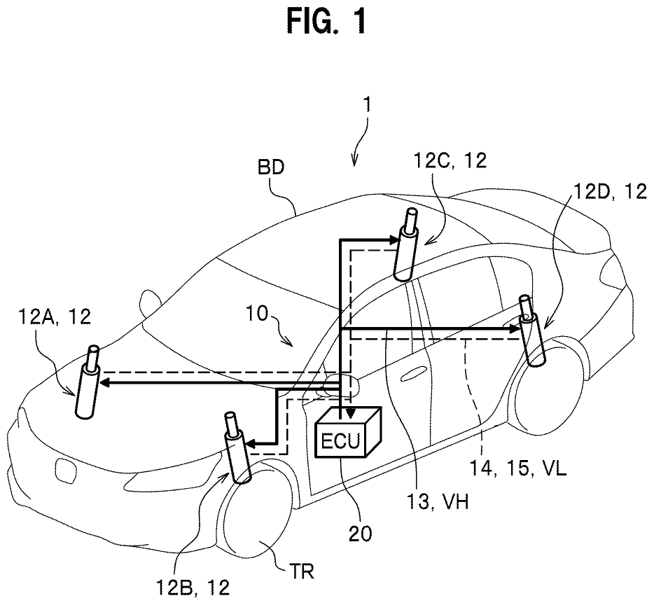

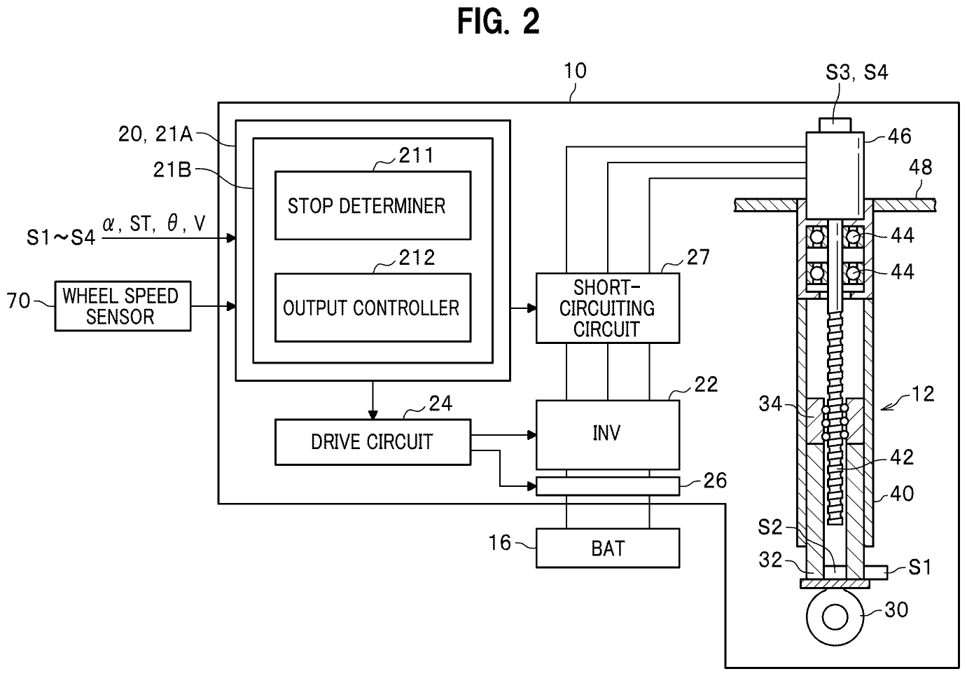

FIG. 1 is a configuration diagram of a vehicle 1 equipped with an electric suspension apparatus 10 that is in accordance with an embodiment of the disclosure. FIG. 2 is a diagram showing a configuration of the electric suspension apparatus 10. Since the electric suspension apparatus 10 is widely incorporated in and integrated with the vehicle 1, the electric suspension apparatus 10 may be considered to be the vehicle itself or may be considered to be provided in the vehicle 1.

Although the vehicle 1 in the present embodiment is a gasoline vehicle, the vehicle 1 may be a diesel vehicle or an electric vehicle (including a hybrid vehicle and a fuel cell vehicle). The present technique may be applied to a vehicle 1 equipped with a high-voltage battery.

As shown in FIG. 1, the vehicle 1 includes a vehicle body BD, four wheels TR, and the electric suspension apparatus 10. The electric suspension apparatus 10 includes electric actuators 12 (high-voltage part) and a control ECU (electronic control unit) 20 (controller) that is an electric suspension control ECU.

The electric actuators 12 are configured to include a first electric actuator 12A, second electric actuator 12B, third electric actuator 12C, and fourth electric actuator 12D. The first electric actuator 12A is arranged between the vehicle body BD and a right front wheel. The second electric actuator 12B is arranged between the vehicle body BD and a left front wheel. The third electric actuator 12C is arranged between the vehicle body BD and a right rear wheel. The fourth electric actuator 12D is arranged between the vehicle body BD and a left rear wheel.

The control ECU 20 controls each of the first electric actuator 12A, second electric actuator 12B, third electric actuator 12C, and the fourth electric actuator 12D. The control ECU 20 is connected to each of the first, second, third, and fourth electric actuators 12A, 12B, 12C, and 12D by a high-voltage line 13, a signal line 14, and a low-voltage line 15.

The high-voltage line 13 supplies electric power of high voltage VH from a battery 16 shown in FIG. 2 to each of the first, second, third, and fourth electric actuators 12A, 12B, 12C, and 12D. The electric power of high voltage VH is used to drive a motor 46 shown in FIG. 2. The high voltage VH is, for example, AC (alternating current) 48 V.

The signal line 14 transmits a detection signal of each of sensors S1, S2, S3, and S4 shown in FIG. 2 to the control ECU 20.

The sensors S1, S2, S3, and S4 will be described with reference to FIG. 2.

The low-voltage line 15 supplies electric power of low voltage VL from the battery 16 shown in FIG. 2 to each of the first, second, third, and fourth electric actuators 12A, 12B, 12C, and 12D. The electric power of low voltage is used for operations of the sensors S1-S4 shown in FIG. 2. The low voltage VL is, for example, DC (direct current) 5 V.

The first, second, third, and fourth electric actuators 12A, 12B, 12C, and 12D include substantially the same configuration. In the following description, each of the first, second, third, and fourth electric actuators 12A, 12B, 12C, and 12D may simply be referred to as an electric actuator 12 in some cases when the first, second, third, and fourth electric actuators 12A, 12B, 12C, and 12D are not distinguished from one another.

Next, a configuration of the electric actuator 12 is described with reference to FIG. 2.

As shown in FIG. 2, the electric actuator 12 includes a connecting portion 30, an inner tube 32, and a nut 34 as members on the wheel TR side. Furthermore, the electric actuator 12 includes an outer tube 40, a threaded shaft 42, a bearing 44, and a motor 46 as members on the vehicle body BD side. The outer tube 40, bearing 44, and motor 46 are fixed to a chassis 48 arranged on a lower portion of the vehicle body BD.

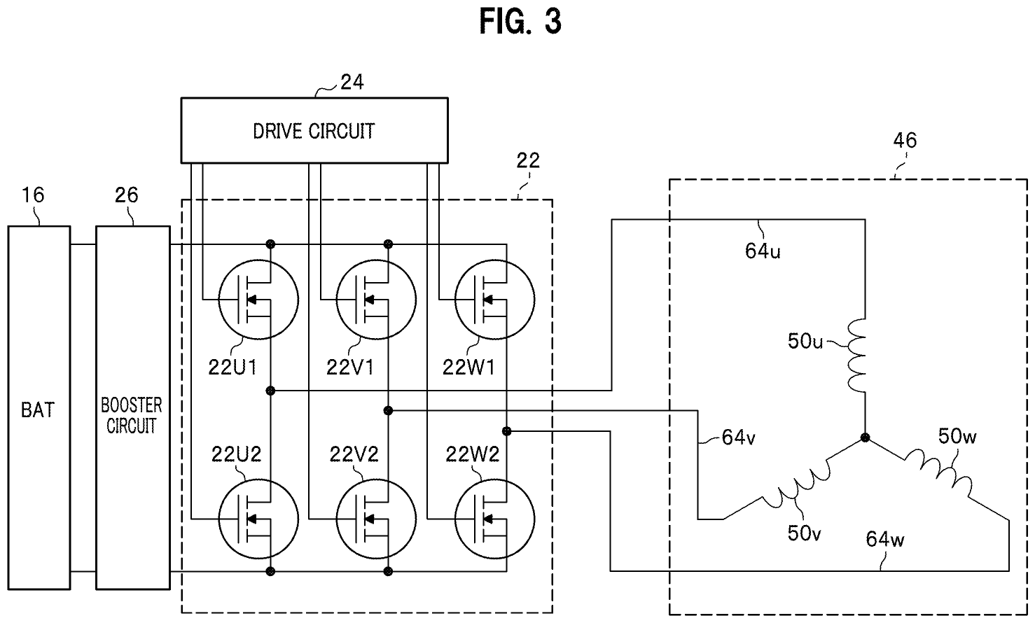

A configuration of the motor 46 will be described with reference to FIG. 3.

The threaded shaft 42 is supported by the bearing 44 and nut 34. An inner surface of the nut 34 is screwed to a thread groove formed on an outer surface of the threaded shaft 42 via a bearing.

Turning the threaded shaft 42 with the motor 46 moves the nut 34 in an upward or downward direction (in other words, in an axial direction of the threaded shaft 42). Moving the nut 34 downward moves the inner tube 32 downward. Moving the nut 34 upward moves the inner tube 32 upward.

In this way, the position of the inner tube 32 along the axial direction relative to the outer tube 40 that is fixed to the chassis 48 of the vehicle body BD may be adjusted.

The connecting portion 30 is fixed to a knuckle (not shown) of a suspension device to be coupled to a wheel TR. When vibration is inputted into the connecting portion 30 from the wheel TR side and upward acceleration α for example is applied to the connecting portion 30, the inner tube 32 and the nut 34 is lifted integrally with the outer tube 40. In this case, the motor 46 rotates the threaded shaft 42 in such a direction that the upward acceleration α is absorbed—that is, in such a direction that the inner tube 32 is moved upward—to damp the vibration from the wheel TR to the vehicle body BD.

The electric actuator 12 is provided with an acceleration sensor S1, a stroke sensor S2, a rotation angle sensor S3, and a voltage sensor S4.

The acceleration sensor S1 is, for example, fixed to an outer peripheral surface of the inner tube 32 and detects the acceleration α applied to the connecting portion 30 from the wheel TR side.

The stroke sensor S2 is arranged on the inner tube 32 at a position facing the threaded shaft 42 and detects a stroke ST indicating an amount of downward movement of the nut 34. The stroke sensor S2 is configured to include a ranging sensor or the like.

The rotation angle sensor S3 is configured to include a so-called resolver, a Hall element, or the like and detects a rotation angle θ of the motor 46.

The voltage sensor S4 detects voltage V applied to the motor 46. In a state where the motor 46 is being driven by the electric power from the battery 16, the voltage V indicates the high voltage VH supplied from the battery 16 via the high-voltage line 13.

The acceleration α, stroke ST, rotation angle θ, and voltage V are outputted to the control ECU 20. The acceleration sensor S1, stroke sensor S2, rotation angle sensor S3, and voltage sensor S4 each correspond to an example of a “sensor”.

As shown in FIG. 2, a wheel speed sensor 70 (part of a stop determination part) measures wheel speed of the vehicle 1. The wheel speed sensor 70 measures the wheel speed of the vehicle 1 and outputs the wheel speed to a stop determiner 211 (stop determination part) of the control ECU 20. The stop determiner 211 determines whether the vehicle 1 is in a stopped state from this vehicle speed information.

Note that the speed of the vehicle 1 (vehicle speed) may be vehicle body speed measured from the wheel speed. In one or more embodiments, vehicle speed may be detected with a vehicle speed sensor (not shown) attached to a transmission or the like.

### Configuration of Control ECU

The control ECU 20 controls the motor 46 via an inverter 22 based on the detection results of the acceleration sensor S1, stroke sensor S2, rotation angle sensor S3, and voltage sensor S4.

A configuration of the inverter 22 will be described with reference to FIG. 3.

The control ECU 20 includes a memory 21A and a processor 21B.

The memory 21A is a storage device that stores data and a program executed by the processor 21B in a non-volatile manner. The memory 21A is formed of a magnetic storage device, a semiconductor storage element such as a flash read only memory (ROM), or another type of a non-volatile storage device. Moreover, the memory 21A may include a random access memory (RAM) that forms a work area of the processor 21B. The memory 21A stores data processed by the control ECU 20 and a control program executed by the processor 21B.

The control ECU 20 corresponds to an example of a “controller”.

The processor 21B may be formed of a single processor. In one or more embodiments, multiple processors may be configured to function as the processor 21B. The processor 21B executes the control program to control parts of the electric suspension apparatus 10.

The control ECU 20 includes the stop determiner 211 and an output controller 212 (output control part). Specifically, the processor 21B of the control ECU 20 functions as the stop determiner 211 and the output controller 212 by executing the control program.

The stop determiner 211 determines whether the vehicle 1 is in a stopped state from the wheel speed information indicating the wheel speed obtained from the wheel speed sensor 70. The stop determiner 211 determines that the vehicle 1 is in a stopped state when, for example, the vehicle speed=0 or almost 0 (including extremely low vehicle speed that may be considered as a stopped state from measurement of the wheel speed sensor 70).

According to the determination result of the stop determiner 211, the output controller 212 stops output of the high voltage VH (including output of a very small amount of high voltage) from the control ECU 20 to the motor 46 of the electric suspension apparatus 10 based on time that elapses after the vehicle 1 reaches a stop (also referred to herein as a “vehicle stop”).

Specified time is set for elapsed time after a vehicle stop in consideration of improving safety of the high-voltage part in a vehicle crash. For example, the specified time is 5 seconds or less. The specified time is predetermined time.

The output controller 212 stops output of the high voltage from the control ECU 20 to the motor 46 within the specified time (5 seconds) from the vehicle stop. To stop the output of the high voltage VH, a drive circuit 24 stops switching of a drive element. Specifically, the output controller 212 causes the drive circuit 24 to keep the inverter 22 fixed to an off state to stop the supply of electric power of high voltage VH to the motor 46.

When the vehicle 1 is in a crash, the output controller 212 stops output of the high voltage to the high-voltage part based on first vehicle stop time (first stop elapse time) after the vehicle 1 crashes. When the vehicle is not in a crash, the output controller 212 stops output of the high voltage to the high-voltage part based on second vehicle stop time (second stop elapse time) after the vehicle 1 stops.

The second vehicle stop time after a vehicle stop described above is within the specified time in which high voltage to the high-voltage part is made absent in a vehicle crash. The first vehicle stop time after a vehicle crash is shorter than the second vehicle stop time.

By setting the first vehicle stop time after a vehicle crash (first stop elapse time) to be shorter than the second vehicle stop time after a vehicle stop (second stop elapse time), high-voltage may be made absent early for a case where the vehicle crash is such that an airbag is activated. Furthermore, by managing the elapsed time, high voltage may be made absent from the high-voltage part when a crash occurs that does not cause the airbag to be activated.

The output controller 212 manages time after the vehicle 1 reaches a stop. The output controller 212 stops the high-voltage output after the vehicle 1 reaches a stop, and then applies an electromagnetic brake by short-circuiting three-phase lines via a short-circuiting circuit 27.

The drive circuit 24 and the inverter 22 will be described with reference to FIG. 3.

### Configuration of Inverter

As shown in FIGS. 2 and 3, the control ECU 20 controls the inverter 22 via the drive circuit 24. The control ECU 20 controls a rotation direction and rotation speed of the motor 46 via the inverter 22. Further, the control ECU 20 stops the supply of electric power of high voltage VH to the motor 46 by, for example, keeping the inverter 22 fixed to an off state. In one or more embodiments, a relay may be provided in a power supply line of the inverter 22 or a booster circuit 26 so that the control ECU 20 may stop the supply of electric power of high voltage VH to the motor 46 by switching off the relay.

FIG. 3 is a diagram showing an example of a configuration of the inverter 22.

The booster circuit 26 is arranged between the battery 16 and the inverter 22. The booster circuit 26 boosts voltage supplied from the battery 16 and supplies the electric power of high voltage VH to the inverter 22. The voltage supplied from the battery 16 is, for example, DC 14 V.

As shown in FIG. 3, the inverter 22 (part of a driving element) includes a metal-oxide-semiconductor field effect transistor (MOSFET) 22U1, a MOSFET 22U2, a MOSFET 22V1, a MOSFET 22V2, a MOSFET 22W1, and a MOSFET 22W2. Each of these six MOSFETS are turned on and off based on an instruction from the control ECU 20.

The motor 46 is, for example, a three-phase brushless AC (alternating current) motor and, as shown in FIG. 3, includes three motors coils: a motor coil 50u, a motor coil 50v, and a motor coil 50w.

The motor 46 rotationally drives the threaded shaft 42 shown in FIG. 2 by using the electric power supplied from the battery 16 via the inverter 22.

The control ECU 20 controls the inverter 22, the booster circuit 26, and the short-circuiting circuit 27 via the drive circuit 24.

When the drive circuit 24 receives an instruction from the output controller 212 to stop the supply of high voltage VH to the motor 46, the drive circuit 24, for example, turns the three MOSFETS on the positive side, which are the MOSFET 22U1, MOSFET 22V1, and MOSFET 22W1, to a fixed, off state. By keeping the MOSFET 22U1, MOSFET 22V1, and MOSFET 22W1 at the off state, a power line 64u, power line 64v, and power line 64w become disconnected from the booster circuit 26. As a result, high voltage VH is stopped from being applied to the motor coil 50u, motor coil 50v, and motor coil 50w of the motor 46.

The booster circuit 26 boosts the voltage (for example, 12 volts to 16 volts) supplied from the battery 16 to high voltage VH and supplies the high voltage VH to the inverter 22. The output controller 212 stops output of the high voltage VH supplied to the motor 46 via the booster circuit 26 (the booster circuit 26 does not perform boosting to the high voltage VH). When the vehicle is not in a crash, the output controller 212 may restore the voltage supplied to the motor 46 via the booster circuit 26 to the high voltage VH.

The battery 16 and booster circuit 26 correspond to an example of a “power supply”.

Further, the control ECU 20 short-circuits the motor 46 via the short-circuiting circuit 27.

The short-circuiting circuit 27 includes a resistor (not shown) and a switch (not shown) that turns on and off according to an instruction from the control ECU 20. The switch of the short-circuiting circuit 27 short-circuits, for example, the power line 64u and power line 64v corresponding respectively to the motor coil 50u and motor coil 50v according to an instruction from the output controller 212. In the above case, the resistor of the short-circuiting circuit 27 adjusts the current that flows in the motor coil 50u and motor coil 50v when the switch short-circuits the power line 64u and power line 64v.

A three-phase short circuit state for the motor coils 50u, 50v, and 50w can be achieved by similarly short-circuiting the power line 64v and power line 64w.

The control ECU 20 limits supply of the high voltage after the vehicle 1 comes to a stop and then short-circuits the three-phase lines via the short-circuiting circuit 27. In other words, the control ECU 20 manages time after the vehicle 1 comes to a stop, stops output of the high voltage VH after the vehicle 1 reaches a stop, and then applies the electromagnetic brake.

High-voltage interruption control of the electric suspension apparatus (vehicle) configured as described above will be described below.

### Flow Chart

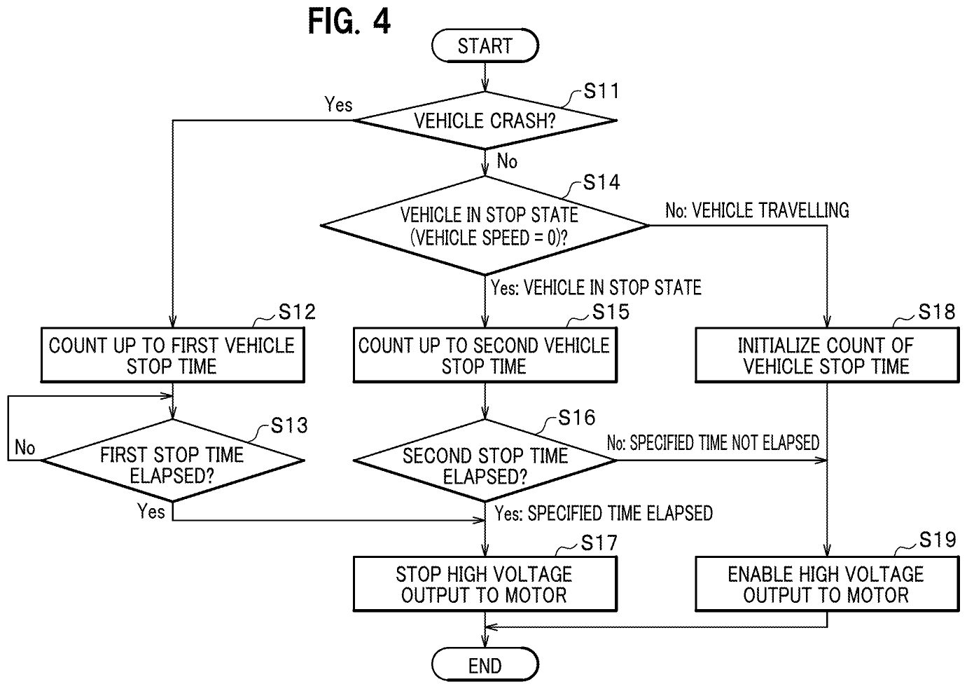

FIG. 4 is a flow chart showing a high-voltage interruption control process of the control ECU 20.

First, in step S11, the control ECU 20 determines whether the vehicle 1 is in a crash. Whether the vehicle 1 is in a crash is determined based on whether an airbag is activated (whether an activation signal of the airbag [activation signal of an SRS sensor] is present).

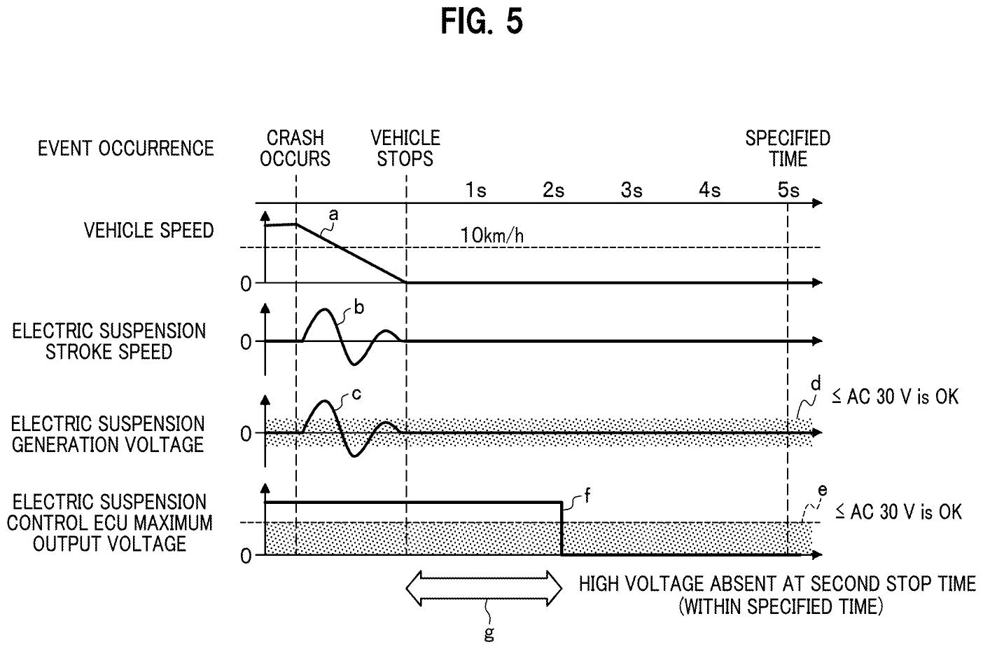

When the vehicle 1 is in a crash (S11: Yes), the process proceeds to step S12, and the output controller 212 counts up to the first vehicle stop time (first stop elapse time) (a timer of the control ECU 20 starts counting time). The first vehicle stop time after a vehicle crash (first stop elapse time) is time for stopping output of the high voltage VH to the motor 46 (FIG. 3) in very short time (for example, 1 second or less) after a vehicle crash. The first vehicle stop time is a period that is equal to or less than the specified time (5 seconds or less) in which to make high voltage to the high-voltage part absent in a vehicle crash. Further, the first vehicle stop time is shorter in period than the second vehicle stop time after a vehicle stop (second stop elapse time; e.g., 2 seconds; see FIG. 5) .

In step S13, the output controller 212 determines whether the first vehicle stop time after a vehicle crash has elapsed.

When the first vehicle stop time after a vehicle crash has not elapsed (S13: No), the output controller 212 waits until the first vehicle stop time elapses. When the first vehicle stop time has elapsed (S13: Yes), the output controller 212 proceeds to step S17.

As described above, the output controller 212 determines whether the first vehicle stop time after a vehicle crash has elapsed or not to stop supply of electric power of high voltage VH to the respective motors 46 of the first, second, third, and fourth electric actuators 12A, 12B, 12C, and 12D as quickly as possible in a vehicle crash. The safety of the electric suspension apparatus 10 in a vehicle crash can be improved.

Meanwhile, when in the above-described step S11 the vehicle 1 is not in a crash (in non-crash of the vehicle) (S11: No), the process proceeds to step S14. In step S14, the stop determiner 211 determines whether the vehicle 1 is in a stopped state or is traveling (determines whether vehicle speed=0).

When the vehicle 1 is in a stopped state (S14: Yes), the process proceeds to step S15. In step S15, the output controller 212 counts up to the second vehicle stop time after a vehicle stop (second stop elapse time) (a timer of the control ECU 20 starts counting time).

In step S16, the output controller 212 determines whether the second vehicle stop time after a vehicle stop (second stop elapse time) has elapsed or not. The second vehicle stop time after a vehicle stop (second stop elapse time) is equal to or less than the specified time (equal to or less than 5 seconds) in which the high voltage to the high-voltage part is made absent in a vehicle crash. In this example, the second vehicle stop time is elapsed time after a vehicle stop (for example, 2 seconds; see FIG. 5) that is shorter than the specified time (of 5 seconds).

When the second vehicle stop time after a vehicle stop has elapsed (S16: Yes), the output controller 212 determines that the specified time has elapsed and proceeds to step S17. When the second vehicle stop time has not elapsed (S16: No), the output controller 212 determines that the specified time has not elapsed and proceeds to step S19.

When, in the above-described step S13, the first vehicle stop time after a vehicle crash has elapsed or when, in the above-described step S16, the second vehicle stop time after a vehicle stop has elapsed, the output controller 212 stops output of the high voltage VH to the motors 46 (FIG. 3) in step S17 then terminates the process of the present flow chart.

Specifically, the output controller 212 stops supply of the high voltage VH to the respective motors 46 of the first, second, third, and fourth electric actuators 12A, 12B, 12C, and 12D. Then, the process ends.

When, in the above-described step S14, the vehicle 1 is traveling (S14: No), the process proceeds to step S18. In step S18, the output controller 212 initializes the count of the second vehicle stop time after a vehicle stop and proceeds to step S19.

When the output controller 212 initializes the count of the second vehicle stop time after a vehicle stop in the above-described step S18 or when the specified time has not elapsed in the above-described step S16, the output controller 212 enables output of the high voltage VH to the motors 46 in step S19 and then ends the process of the present flow chart.

### Timing Chart

FIG. 5 is a timing chart showing an example of the high-voltage interruption control of the control ECU 20 of the electric suspension apparatus 10. The horizontal axis indicates time (in seconds). The vertical axes indicate occurring events, vehicle speed, electric suspension stroke speed, electric suspension generation voltage, and electric suspension control ECU maximum output voltage.

As shown by reference sign a of FIG. 5, when a vehicle 1 crashes while traveling, vehicle speed keeps on decreasing until the vehicle 1 stops (vehicle speed=0).

After the crash and until the vehicle 1 stops, the electric suspension stroke speed fluctuates due to being affected by the crash of the vehicle 1 (see reference sign b of FIG. 5), and the electric suspension generation voltage also fluctuates (see reference sign c of FIG. 5).

When the vehicle 1 stops, the electric suspension stroke speed becomes zero. Since the electric suspension generation voltage is generated voltage that depends on the stroke speed, the electric suspension generation voltage becomes zero (see the shaded portion d in FIG. 5).

In the case of a crash in which the airbag is activated, the maximum output voltage of the electric suspension control ECU is set to AC (alternating current) 30 V or less in conjunction with a crash signal that activates the airbag.

However, in the case of a crash in which the airbag is not activated (such a case can arise not only when the crash is minor but also when the SRS sensor does not detect a crash in a major crash), the output of the high voltage VH to the motors 46 (FIG. 3) will not be made absent. Specifically, the high voltage of the high-voltage part can be made absent only when there is an occurrence of a crash in which an activation signal of the airbag is detected.

In the present embodiment, the high-voltage output to the motors 46 of the electric suspension from the control ECU 20 is stopped based on time that elapses after the vehicle 1 reaches a stop. As a specific example, the high-voltage output from the control ECU 20 to the motors 46 is stopped when a certain amount of time has elapsed after a vehicle stop (for example, when 2 seconds have elapsed after the vehicle 1 stops; see reference sign f of FIG. 5). As shown by a two-headed arrow g outlined in FIG. 5, even when a crash is not enough to activate the airbag, the high voltage VH to the motors 46 may be made absent in predetermined elapse time (2 seconds in this example) from a vehicle stop by using a stopping of the vehicle 1 as a trigger.

As shown in FIG. 5, the supply of high voltage VH is limited within predetermined time (2 seconds) from a stopping of the vehicle 1. Accordingly, the high voltage can be made absent irrespective of a form of crash, and the safety of the electric suspension apparatus 10 can be improved.

### Effects

An object of an aspect of the disclosure is to provide an electric suspension apparatus and a vehicle that can make high voltage absent from a high-voltage part in a crash in a case where an airbag of the vehicle is not activated.

According to an aspect of the disclosure, a high-voltage part can be made absent of high voltage in a case where an airbag is not activated in a crash.

As described above, an electric suspension apparatus 10 that is provided in a vehicle 1 according to an embodiment includes: an electric actuator 12 (high-voltage part) to which high voltage is supplied from a battery 16 (power supply); and a control ECU 20 that controls the battery 16 and the electric actuator 12. The control ECU 20 includes a stop determiner 211 that determines whether the vehicle 1 is in a stopped state and an output controller 212 that stops output of the high voltage to the electric actuator 12 based on time that elapses after the vehicle 1 stops.

This configuration may make a high voltage absent from the high-voltage part irrespective of a form of crash. Therefore, the high voltage may be made absent in a crash in which an airbag of the vehicle 1 is not activated. In this way, the safety of the high-voltage part can be improved.

Moreover, since the need for damper control is low in the stopped state, electric power consumption can be suppressed.

Furthermore, because the disclosure is based on elapsed time after a vehicle stop, the high voltage of the high-voltage part may be made absent irrespective of a form of crash. A motor 46 of the electric suspension apparatus 10 does not have to be arranged in a physically protected area in a center portion of the vehicle 1. Accordingly, the motor 46 can be directly mounted at a position where the electric suspension apparatus 10 is mounted and driving via a link is unnecessary. Size reduction of the system can thus be achieved.

Using the vehicle stop as a trigger of the high-voltage interruption control enables the high voltage of the high-voltage part to be made absent in a case where a level of crash is such that the airbag is not activated.

In one or more embodiments, the electric actuator 12 (high-voltage part) includes a motor 46, and the output controller 212 stops high-voltage output to the motor 46.

Accordingly, when the electric actuator 12 (high-voltage part) includes a motor 46, high voltage to the motor 46 may be made absent and the safety of the electric actuator 12 can be improved.

In one or more embodiments, the motor 46 is a three-phase motor and the output controller 212 is configured to stop high-voltage output after the vehicle 1 stops and then apply electromagnetic brake by short-circuiting the three-phase lines of the three-phase motor.

Accordingly, the control ECU 20 short-circuits the motor 46 when the vehicle 1 is in a stopped state. When the motor 46 is short-circuited, damping force can be generated by the application of electromagnetic brake of the motor 46 on a stroke motion of the electric actuator 12, and thus the stroke motion of the electric actuator 12 can be damped.

In one or more embodiments, the high-voltage part includes a motor 46 and a drive element that drives the motor 46, and the output controller 212 is configured to stop switching of the drive element.

Accordingly, when the electric actuator 12 (high-voltage part) includes the motor 46, stopping the switching of the drive element can stop the operation of the motor 46. Since no electric power is consumed in a state where the switching of the drive element is stopped, power consumption in the stopped state can be suppressed.

In one or more embodiments, the output controller 212 is configured to: stop output of the high voltage to the high-voltage part based on first vehicle stop time after a vehicle crash (first stop elapse time) when the vehicle 1 is in a crash; and stop output of the high voltage to the high-voltage part based on second vehicle stop time after a vehicle stop (second stop elapse time) when the vehicle 1 is not in a crash.

In this way, the high voltage may quickly be made absent in a case where the vehicle 1 crashes and stops.

In one or more embodiments, the first vehicle stop time after a vehicle crash (first stop elapse time) is shorter than the second vehicle stop time.

Accordingly, the high voltage may quickly be made absent in a case of a vehicle crash in which the airbag is activated, while the high voltage of the high-voltage part may be made absent in a case where a crash is at a level that does not activate the airbag.

The above-described embodiments have been described in detail to describe the disclosure in an easily understandable manner. The disclosure is not necessarily limited to an embodiment including the entire configuration described above.

For example, although the aforementioned embodiment has been described for a case where the “high-voltage part” includes electric actuators 12, the disclosure is not limited to this case. The “high-voltage part” may for example include an in-wheel motor, an air conditioner, a traction motor, or an electric stabilizer.

Moreover, although the above-described embodiment has been described for a case where the “power supply” includes a battery 16, the disclosure is not limited to this case. The “power supply” may include a power generator such as an alternator.

Furthermore, although the above-described embodiment has been described for a case where the output controller 212 keeps the inverter 22 fixed at an off state to disconnect the motors 46, the disclosure is not limited to this case. For example, the electric suspension apparatus 10 may be configured to include an opening circuit for disconnecting the motors 46, and the output controller 212 may disconnect the motors 46 via the opening circuit. Alternatively, a relay may be provided on a power line of the inverter 22 or the booster circuit 26, and the output controller 212 may shut off the relay to stop power supply to the motor 46.

The functional blocks shown in FIG. 2 may at least be partially implemented by hardware or may be implemented by hardware and software, and the disclosure is not limited to a configuration in which independent hardware resources are arranged as shown in the drawings.

Although the control program executed by the processor 21B in the control ECU 20 of the electric suspension apparatus 10 is stored in the memory 21A, the control program may be stored in an external hard disk drive (HDD) or the like.

Processing units of the flow chart shown in FIG. 4 has been obtained by dividing the main processing contents of the process of the control ECU 20 in the electric suspension apparatus 10 so as to aid the understanding of the process. The embodiment is not limited by the way in which the process has been divided up into processing units or by the names of the processing units as shown in the flow chart of FIG. 4. The process of the control ECU 20 may be divided into more processing units according to the processing contents. The division may be performed so that one processing unit includes more processes according to the processing contents. The processing order of the above-described flow chart is not limited to the illustrated example.

The control method of the control ECU 20 may be implemented by causing the processor 21B of the control ECU 20 to execute a control program corresponding to the control method of the control ECU 20. The control program may be recorded in advance in a non-transitory computer-readable storage medium. A magnetic or optical storage medium or a semiconductor memory device may be used as the non-transitory storage medium. The non-transitory storage medium may be a fixed storage medium or a portable storage medium. Specific examples of the non-transitory storage medium include a flexible disk, a compact disk read only memory (CD-ROM), a digital versatile disc (DVD), a Blu-ray (registered trademark) disc, a magneto-optical disc, a flash memory, and a card-type recording medium. The non-transitory storage medium may be a non-volatile storage device such as a RAM, a ROM, or an HDD that is an internal storage device included in the electric suspension apparatus 10. The configuration may be such that the control program corresponding to the control method of the control ECU 20 of the electric suspension apparatus 10 is stored in an external server or the like, and the control ECU 20 may download the control program from the external server to implement the control method of the control ECU 20.

What is claimed is:

1. An electric suspension apparatus that is provided in a vehicle, comprising:
a high-voltage part configured to be supplied with a high voltage from a power supply; and
a controller configured to control the power supply and the high-voltage part, wherein
the controller includes:
a stop determination part configured to determine whether the vehicle is in a stopped state; and
an output control part configured to limit output of the high voltage to the high-voltage part based on time that elapses after the vehicle stops.

2. The electric suspension apparatus according to claim 1, wherein
the high-voltage part includes a motor, and
the output control part is configured to stop high-voltage output to the motor.

3. The electric suspension apparatus according to claim 2, wherein
the motor is a three-phase motor, and
the output control part is configured to stop high-voltage output after the vehicle stops and then short-circuit three-phase lines of the three-phase motor to apply an electromagnetic brake.

4. The electric suspension apparatus according to claim 1, wherein
the high-voltage part includes a motor and a drive element configured to drive the motor, and
the output control part is configured to stop switching of the drive element.

5. A vehicle, comprising:
a power supply;
a high-voltage part configured to be supplied with a high voltage from the power supply; and
a controller configured to control the power supply and the high-voltage part, wherein
the controller includes:
a stop determination part configured to determine whether the vehicle is in a stopped state; and
an output control part configured to limit output of the high voltage to the high-voltage part based on time that elapses after the vehicle stops.

6. The vehicle according to claim 5, wherein
the output control part is configured to:
stop, when the vehicle is in a crash, output of the high voltage to the high-voltage part based on first stop elapse time after the vehicle crashes; and
stop, when the vehicle is not in a crash, output of the high voltage to the high-voltage part based on second stop elapse stop time after the vehicle stops.

7. The vehicle according to claim 6, wherein the first stop elapse time is shorter than the second stop elapse time.
